(19) United States
(12) Patent Application Publication
(10) Pub. No.: US 2017/0288203 A1
(43) Pub. Date: Oct. 5, 2017

(54) Bending Tool

(71) Applicant: Faraday&Future Inc., Gardena, CA (US)

(72) Inventors: Steven Harold Offutt, Costa Mesa, CA (US); Hrayr Torosyan, Sunland, CA (US)

(73) Assignee: Faraday&Future Inc.

(21) Appl. No.: 15/085,325

(22) Filed: Mar. 30, 2016

(51) Int. Cl. H01M 2/30; H01R 43/16

(52) U.S. Cl. CPC H01M 2/30; H01R 43/16

(57) ABSTRACT

A bending tool is disclosed. The bending tool may include a male fixture that may have a projection with an outer surface and a female fixture that may be configured to receive the projection. The female fixture may have a first height in a direction that is substantially parallel to the projection. The bending tool may also include a positioning device, which may be disposed between the male fixture and the female fixture. The male fixture may be configured to move between a starting position and an ending position in which the outer surface of the projection is received by the female fixture at a pre-determined distance below the first height.

### TECHNICAL FIELD

The present disclosure is directed to a bending tool, and particularly a bending tool for use in bending the positive and negative terminals of a circuit board.

### BACKGROUND

Certain batteries have been developed in which a circuit board including positive and negative contacts may be disposed on a group of battery cells. The circuit board may provide electrical connectivity between selected cells, however to achieve an electrical connection the circuit board must be in precise contact with the cells. To achieve this, the positive and negative contacts on the circuit board may be consistently bent to pre-determined heights in order to ensure that the contacts are connected to the correct terminals of the battery. The contacts may then be laser-welded to the battery terminals. Bending each contact manually into place may be imprecise and/or time consuming.

The disclosed tool is directed to addressing one or more of the problems set forth above and/or other problems of the prior art, and to providing a bending tool for use with circuit boards.

### SUMMARY

In one aspect, the present disclosure is directed to a bending tool. The bending tool may include a male fixture that may have a projection with an outer surface and a female fixture that may be configured to receive the projection. The female fixture may have a first height in a direction that is substantially parallel to the projection. The bending tool male also include a positioning device, which may be disposed between the male fixture and the female fixture. The male fixture may be configured to move between a starting position and an ending position in which the outer surface of the projection is received by the female fixture at a pre-determined distance below the first height.

In another aspect, the present disclosure is directed to a bending tool. The bending tool may include a male fixture that may have a projection with an outer surface and a female fixture that may be configured to receive the projection. The female fixture may have a first height in a direction substantially parallel to the projection and may include a fixed portion and a movable portion. The movable portion may be configured to move from a resting height in a direction substantially parallel to the projection to a second height below the first height. The bending tool may also include a positioning device, which may be disposed between the male fixture and the female fixture. The male fixture may be configured to move between a starting position and an ending position in which the outer surface of the projection is received by the female fixture at a pre-determined distance below the first height. The projection may cause the movable portion to move from the resting height to the second height when the male fixture is received by the female fixture.

In yet another aspect, the present disclosure is directed to a bending tool for bending contacts on a circuit board. The bending tool may include a plurality of male fixtures, each having a projection with an outer surface, and a plurality of female fixtures each configured to receive the projection of a corresponding male fixture. Each of the female fixtures may have a first height in a direction substantially parallel to the projection of the corresponding male fixture. The bending tool may further include a positioning device configured to hold the circuit board such that each contact is positioned between one of the plurality of female fixtures and its corresponding male fixture. Each of the male fixtures may move between a starting position and an ending position in which the outer surface of the projection of the male fixture is received by the corresponding female fixture at a pre-determined distance below the first height.

### BRIEF DESCRIPTION OF THE DRAWINGS

FIG. 1 is a diagrammatic illustration of an exemplary circuit board;

FIG. 2 is a diagrammatic illustration of a first exemplary bending tool;

FIG. 3 is a diagrammatic illustration of the first exemplary bending tool and an unbent circuit board before applying the bending tool;

FIG. 4 is a diagrammatic illustration of the first exemplary bending tool and a bent circuit board after applying the bending tool;

FIG. 5 is a diagrammatic illustration of a second exemplary bending tool;

FIG. 6 is a diagrammatic illustration of a third exemplary bending tool;

FIG. 7 is a diagrammatic illustration of a male fixture of a fourth exemplary bending tool;

FIG. 8 is a diagrammatic illustration of a female fixture of the fourth exemplary bending tool; and

FIG. 9 is a diagrammatic illustration of a fourth exemplary bending tool.

### DETAILED DESCRIPTION

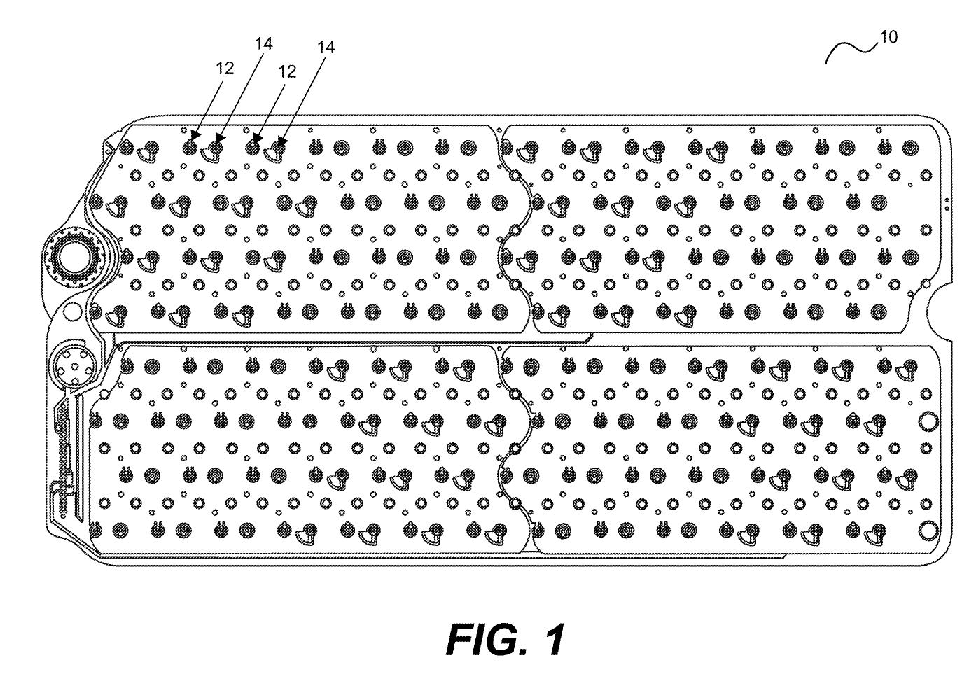

FIG. 1 is a diagrammatic illustration of an exemplary circuit board 10. Circuit board 10 includes a plurality of negative contacts 12 and a plurality of positive contacts 14. It is contemplated that circuit board 10 may include more or fewer contacts than shown. Circuit board 10 may be generally planar, and may be of any desired size and dimensions. Circuit board 10 may be in electrical connection with one or more battery cells, and may conduct current between battery cells through, e.g., negative contacts 12 and positive contacts 14. For example, each positive contact 14 may be bent such that it is in electrical contact with a cathode terminal of a battery cell and each negative contact 12 may be bent such that it is in electrical contact with an anode terminal of a battery cell.

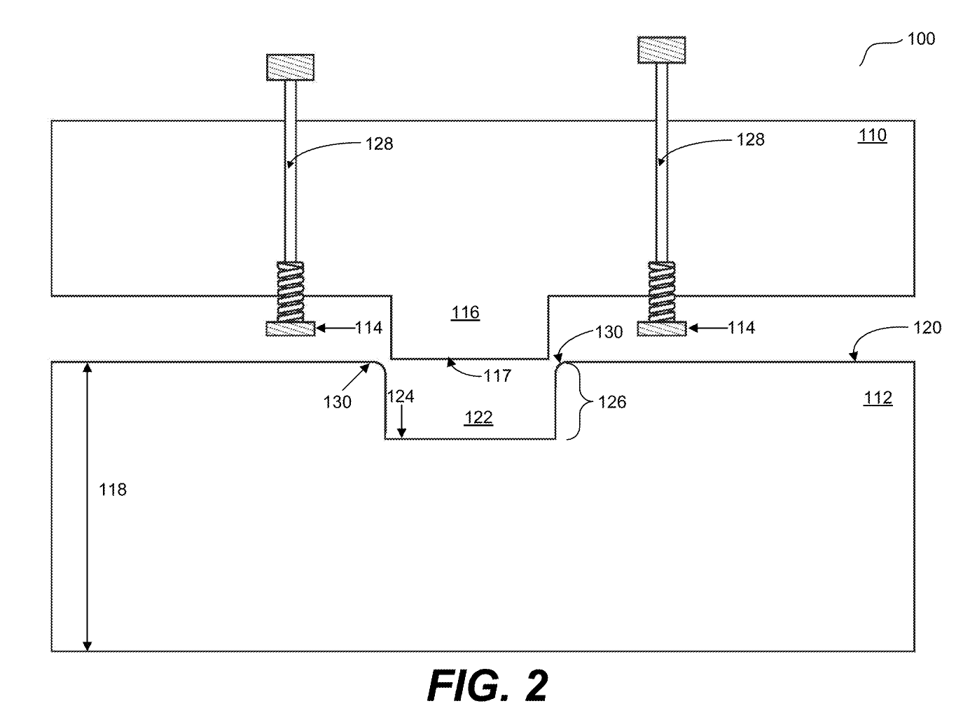

FIG. 2 is a diagrammatic illustration of a first exemplary bending tool 100. Bending tool 100 may include male fixture 110, female fixture 112, and one or more positioning devices 114.

Male fixture 110 may be of any size or dimensions and may be of any materials suitable for the application, (e.g., the type of circuit bending tool 100 is used to bend). In some exemplary embodiments, male fixture 110 may be composed of hardened tool steel. Male fixture 110 may include projection 116.

Projection 116 may extend outward from a surface of male fixture 110. Projection 116 may be of the same materials as male fixture 110, or may be of a different material. For example, projection 116 may be composed of a ceramic while male fixture 110 may be composed of hardened tool steel. Projection 116 may be of any shape and dimensions. Though shown as a rectangular projection, it is contemplated that projection 116 may be square, oval, round, stepped, annular, or any other shape, and may be of any dimensions suitable for the size of the contact of other object to be bent. Further, it is contemplated that outer surface 117 of projection 116, e.g., the surface furthest from male fixture 110, may be uniform or non-uniform (e.g., flat or non-flat, smooth or non-smooth). For instance, some portion of outer surface 117 may extend further from male fixture 110 than other portions. In addition, male fixture 110 may include multiple projections 116, which may be of the same shape and dimensions with respect to one another or may be different. Projection 116 applies a force on the contact of the circuit board (the portion of the object to be bent).

Projection 116 extends from male fixture 110 towards female fixture 112. Male fixture 110 and female fixture 112 may be disposed opposite one another, and female fixture 112 may be configured to receive projection 116. Male fixture 110 and female fixture 112 may be mechanically connected (e.g., by clamps, ties, pins, snaps, etc.) or may be separate.

Female fixture 112 and male fixture 110 may be oriented vertically (i.e., with male fixture 110 above female 112 or vice versa), horizontally (i.e., with male fixture 110 to the left of female fixture 112 or vice versa) or at some other angle.

Female fixture 112 may be of any size or dimensions and may be of any materials suitable for the application, e.g., the type of circuit bending tool 100 is used to bend. In some exemplary embodiments, female fixture 112 may be composed of hardened tool steel. Female fixture 112 may have a first height 118 defined in the direction substantially parallel to projection 116. Female fixture 112 may also have a top surface 120 substantially perpendicular to projection 116 and top surface 120 may be substantially parallel to outer surface 117 of projection 116.

Female fixture 112 may further include nest 122. Nest 122 may be recessed into top surface 120 of female fixture 112 and may be sized and dimensioned such that it is configured to receive projection 116. When female fixture 112 is disposed opposite to male fixture 110, nest 122 may be aligned with projection 116.

Bottom 124 of nest 122 may be a distance 126 below first height 118. Distance 126 may be fixed or may be varied. For example, bottom 124 can rest on dowels or other movable supports such that it may be adjusted, or bottom 124 may be removable, in order to switch bottom 124 for other bottoms of different shapes and/or dimensions. In addition or alternatively, a booster component (not shown) may be inserted into nest 122 in order to decrease distance 126. Similarly, the dimensions of nest 122 may be altered by inserting additional components (e.g., donuts, bolsters, steps, etc.) to vary the shape and/or dimensions of nest 122. In other embodiments, the position of bottom 124 of nest 122 may be fixed.

The contours of bottom 124 may be shaped to match the contours of outer surface 117. Nest 122 may further include a mouth with curved edges 130. The shape and dimensions of nest 122 may dictate the shape of the bend in the contact or other object to be bent.

Female fixture 112 may include a single nest 122 or may include multiple nests 122 in order to receive multiple projections 116. In embodiments featuring multiple nests 122, each of nests 122 may be of the same shape and dimensions, or some or all of nests 122 may be of different shapes and/or dimensions.

Bending tool 100 may also include one or more positioning devices 114. Positioning devices 114 may include spring-loaded pins (as depicted), and may additionally or alternatively include clamps, adhesives, stakes, pins, etc., or some combination thereof. It is contemplated that foam or another material may be substituted for the springs of positioning devices 114. Positioning devices 114 may be connected to male fixture 110. In some embodiments, positioning device 114 may be connected to a shaft 128 that extends through male fixture 110, as depicted. Alternatively or in addition, positioning devices 114 may be connected to female fixture 112. Positioning device 114 may act to hold the circuit board or other object to be bent in position, and may be disposed between male fixture 110 and female fixture 112. It is contemplated that bending tool 100 may include multiple positioning devices 114. Positioning devices 114 may be disposed symmetrically about nest 122 or may be disposed asymmetrically.

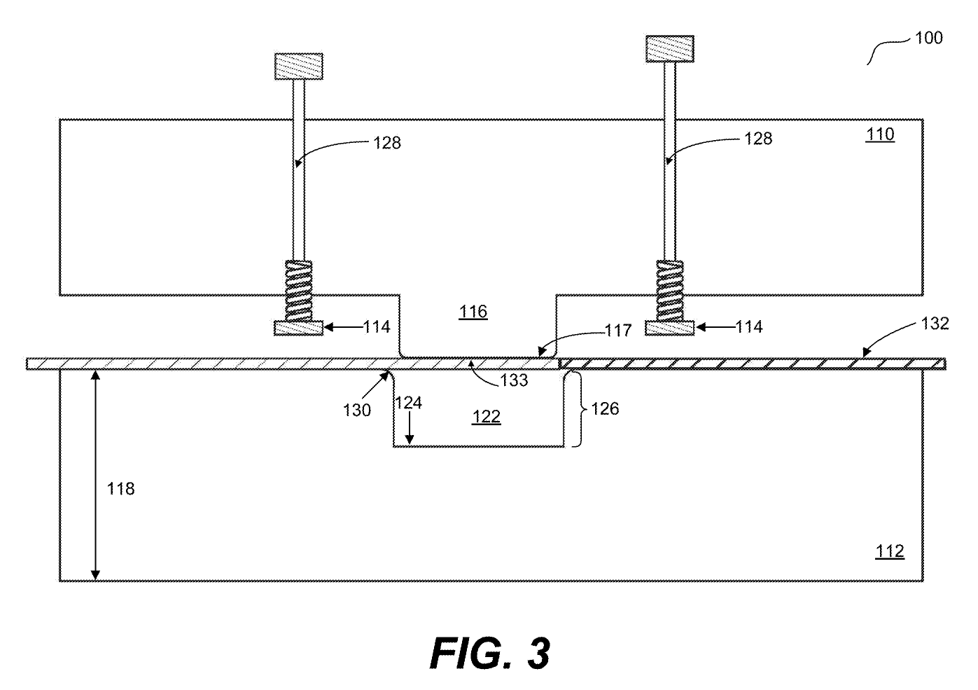

FIG. 3 is a diagrammatic illustration of a circuit board 132 disposed in bending tool 100 prior to contact 133 of circuit board 132 being bent. As shown, circuit board 132 may be positioned between male fixture 110 and female fixture 112. The portion of the circuit board to be bent, contact 133, may be positioned between projection 116 and nest 122.

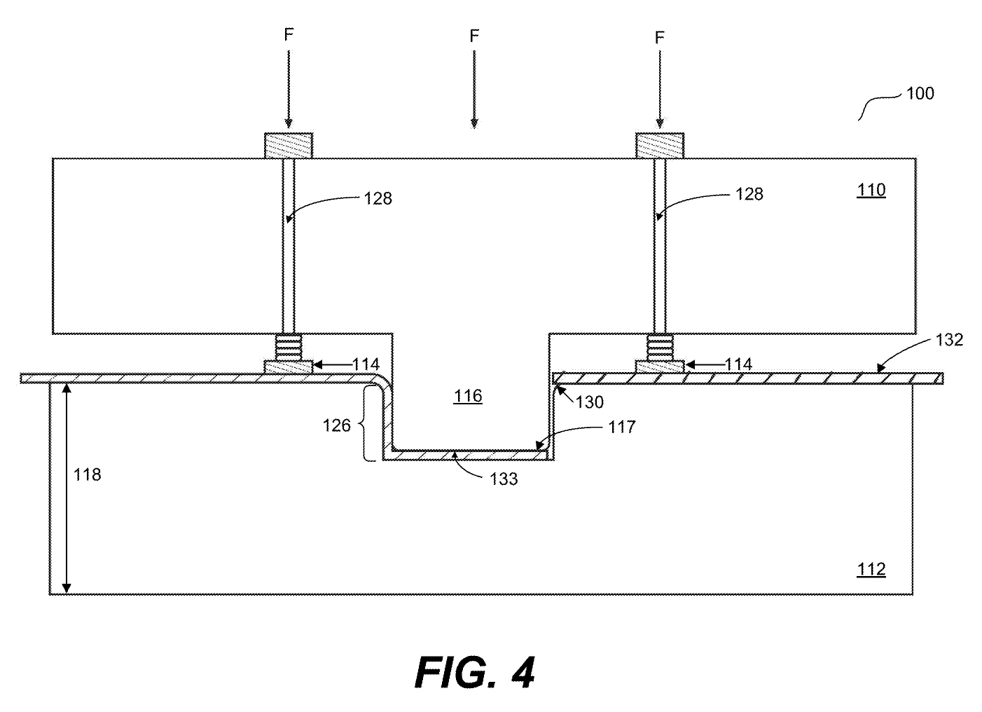

FIG. 4 is a diagrammatic illustration of the first exemplary bending tool and a bent circuit board after applying the bending tool. As shown in FIG. 4, a force F may be applied to male fixture 110. Force F may push shafts 128 of positioning devices 114 towards top surface 120 of female fixture 112, and may cause positioning devices 114 to hold circuit board 132 in place. Force F may also push male fixture 110 from its starting position toward female fixture 112 to an ending position, as shown in FIG. 4.

As male fixture 110 moves towards female fixture 112, projection 116 presses on circuit board 132, bending contact 133 of circuit board 132 into nest 122. Curved edges 130 at the mouth of nest 122 may minimize the stress on circuit board 132 as contact 133 is bent into nest 122.

In the ending position, projection 116 may be received by female fixture 112 in nest 122, such that outer surface 117 of projection 116 is at a predetermined distance below first height 118 when male fixture 110 reaches its ending position. This predetermined distance is dictated by distance 126 and the height (in the direction substantially parallel to projection 116) of contact 133.

Force F can be applied by a ram, which may be mechanical and may be run electrically, pneumatically, manually, or by other means known in the art. Alternatively or in addition, force F may be applied by hand. In embodiments using a ram, male fixture 110 may be affixed to the ram, or the ram may be a separate piece. Rather than being applied to male fixture 110, force F may alternatively be applied to female fixture 112. Like male fixture 110, female fixture 112 may be fixed to a ram, such that female fixture 112 moves towards male fixture 110. In other embodiments, force may be applied to both male fixture 110 and female fixture 112, such that male fixture 110 and female fixture 112 move towards one another. In such embodiments, both male fixture 110 and female 112 may be fixed to respective rams.

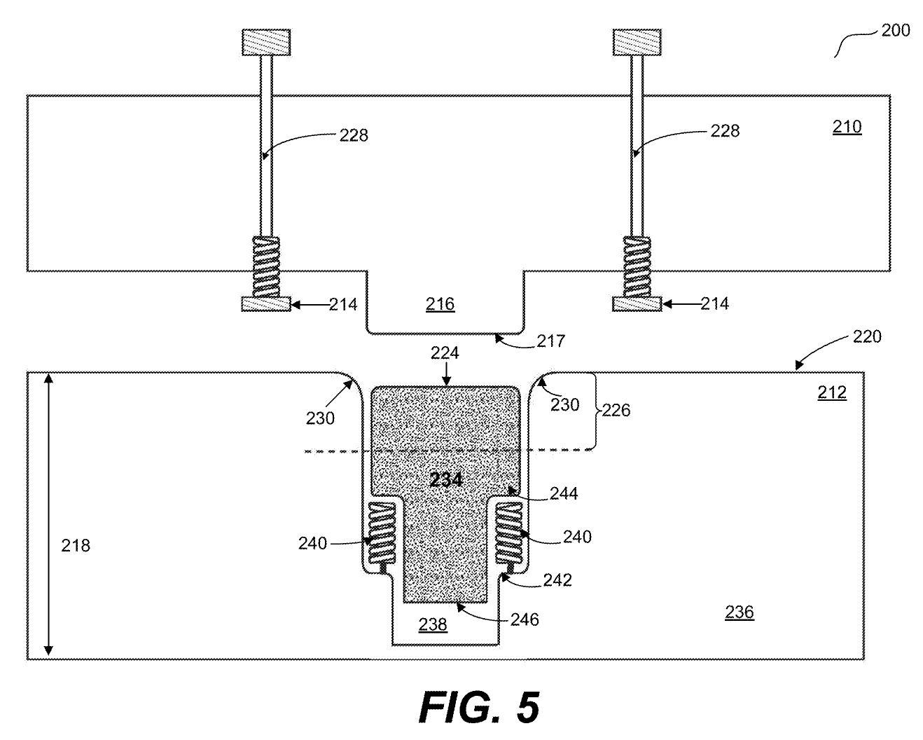

FIG. 5 is a diagrammatic illustration of a second exemplary bending tool 200. Components similar to those found in the previously disclosed bending tool 100 are identified with similar reference numerals. To avoid duplicative description, only those components different from those found in the previously disclosed bending tool 100 are described in detail.

As shown, bending tool 200 may include a male fixture 210, which may include a projection 216 which may have an outer surface 217. Bending tool 200 may further include positioning devices 214, which may be affixed to shafts 228 and may extend through male fixture 210. Bending tool 200 may also include a female fixture 212, and a positioning device 214 may be positioned between male fixture 210 and female fixture 212.

Female fixture 212 may have a first height 218 in the direction substantially parallel to projection 216 and may have a top surface 220, which may be substantially parallel to outer surface 117 of projection 216. Female fixture 212 may include a movable portion 234 and a fixed portion 236.

Fixed portion 236 may define a channel 238, in which movable portion 234 may be positioned. Channel 238 may have curved edges 230. Movable portion 234 may be disposed such that movable portion 234 may be aligned with projection 216 when female fixture 212 is positioned opposite male fixture 210.

The shape and dimensions of movable portion 234 may be configured to mirror those of projection 216. Movable portion 234 may have a top 224, whose surface may be shaped to match the contours of outer surface 217 of projection 216. Movable portion 234 may be positioned on springs 240. Springs 240 may bias movable portion 234 towards male fixture 210 such that top 224 of movable portion 234 rests at a resting height substantially similar to first height 218 of female fixture 212, though it is also contemplated that the resting height (e.g., the position of moving portion 234 as shown in FIG. 5) of movable portion 234 may be different than height 218 of female fixture 212. Movable portion 234 may be configured to move between this resting height and a second height some distance 226 below first height 218 of female fixture 212. For example, when force is applied on top 224 of movable portion 234, springs 240 may be compressed and movable portion 234 may move from its resting height to the second height a distance 226 below first height 218.

The movement of movable portion 234 from the resting height to the second height may define a nest 222, in which top 224 of movable portion 234 may form the bottom of nest 222. Nest 222 may extend distance 226 below height 218 of female fixture 212.

Springs 240 may be positioned between a lip 244 of movable portion 234 and a neck 242 of channel 238, as shown. Alternatively or in addition, springs 240 may be positioned between a base 246 of movable portion 234 and a bottom of channel 238. Although FIG. 5 shows two springs 240, it is contemplated that any suitable number of springs 240 may be used.

Springs 240 may be removable, allowing springs or different dimensions or rigidity to be substituted in order to vary distance 226. Similarly, in addition or alternatively, movable portion 234 may be replaceable with a movable portion having different dimensions, allowing distance 226 to be varied.

The operation of bending tool 200 may be similar to the operation of bending tool 100. A circuit board with a contact (not shown) or other object to be bent may be inserted between female fixture 212 and male fixture 210 and a force may be applied to move male fixture 210 towards female fixture 212. The force may cause positioning devices 214 to hold the circuit board in position. As male fixture 210 moves from its starting position towards an ending position, projection 216 may move movable portion 234 in channel 238 to its second height distance 226 below top surface 220. The movement of movable portion 234 may form nest 222 in which outer surface 217 of projection 216 may be received by female fixture 212 at a predetermined distance below first height 218, which is again determined by the distance 226 and the height of contact 233. This may result in a contact of the circuit board being bent into a predefined shape.

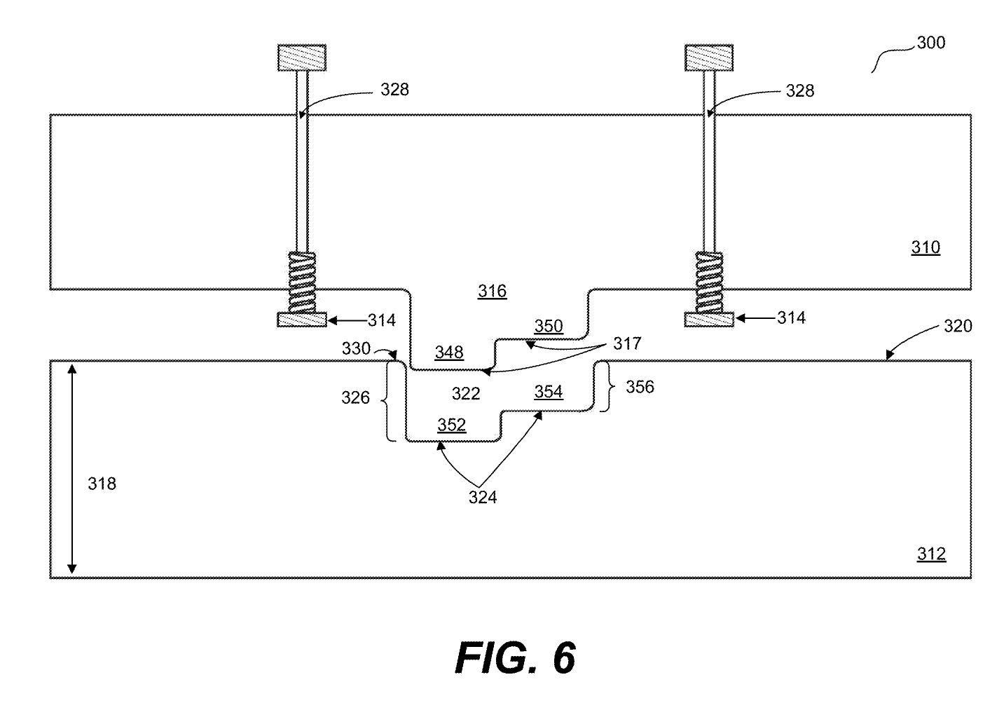

FIG. 6 is a diagrammatic illustration of a third exemplary bending tool 300. Components similar to those found in the previously disclosed bending tools (e.g., 100 and 200) are identified with similar reference numerals. To avoid duplicative description, only those components different from those found in the previously disclosed bending tools are described in detail.

Bending tool 300 may include a male fixture 310, a female fixture 312, and positioning devices 314, which may be connected to shafts 328. Male fixture 310 may have a projection 316, which may have an outer surface 317. Female fixture 312 may have a height 318 in the direction substantially parallel to the projection, a top surface 320, and a nest 322 recessed into top surface 320. Nest 322 may have a bottom 324 whose contours may match those of outer surface 317.

Outer surface 317 of projection 316 may include two portions 348 and 350. Portion 348 may extend further from male fixture 310 than portion 350. It is contemplated that more portions may be used, such that outer surface 317 might form a crenelated pattern, a bulls-eye pattern, a stair-step patter, a ring pattern, etc.

Similarly, bottom 324 of nest 322 may include two portions. Portion 352 may be a distance 326 below height 318, and portion 354 may be a distance 356 below height 318. Distance 326 may be greater than distance 356, and portion 352 may be aligned with portion 348 of outer surface 317 when male fixture 310 is disposed opposite female fixture 312. It is again contemplated that bottom 324 of nest 322 may include more than two portions, which may form a crenelated pattern, a bulls-eye pattern, a stair-step patter, a ring pattern, etc.

The operation of bending tool 300 may be similar to the operation of bending tool 100, except in that only portion 348 of outer surface 317 of projection 316 is received at the predetermined distance below first height 318. The predetermined distance is again set based on distance 326 and the height of the contact to be bent. Similarly, portion 350 of outer surface 317 may be received by female fixture 312 at a second predetermined distance below height 318, the second predetermined distance being set by distance 356 and the height of the contact to be bent. It is contemplated that portion 348 and portion 350 may act to bend a single contact into a stair-step or other pattern, or that portion 348 and portion 350 may bend two different contacts of the circuit board. It is also contemplated that only one of portions 348 and 350 may bend the contact of the circuit board.

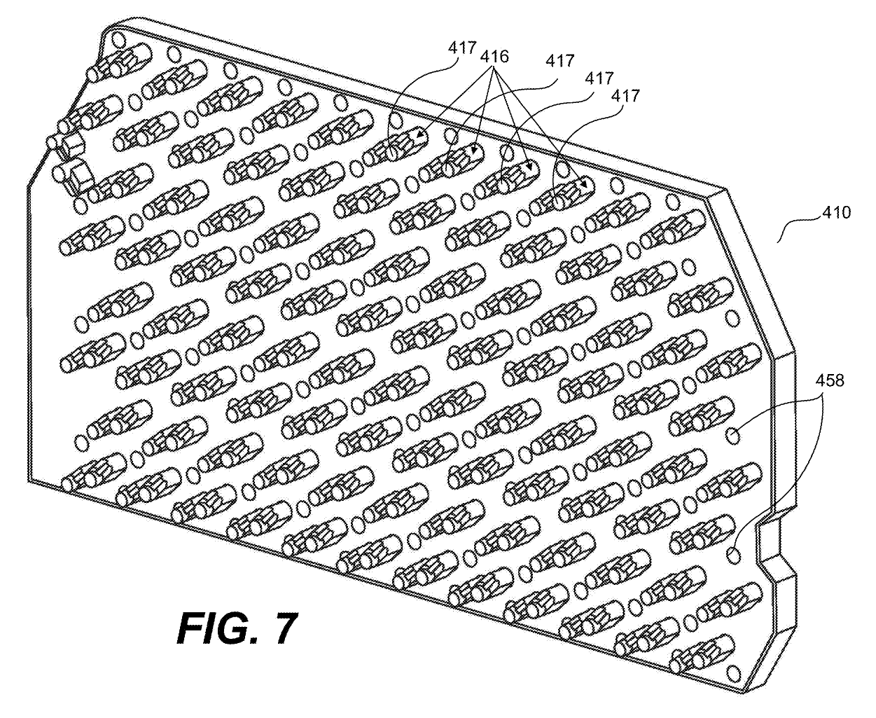

FIGS. 7-9 illustrate a fourth exemplary bending tool 400. FIG. 7 is a diagrammatic illustration of an exemplary male fixture 410 of a fourth exemplary bending tool 400. Male fixture 410 may include a plurality of projections 416 that extend from male fixture 410. Each of the plurality of projections 416 may be of the same shape and dimensions, or one of more the projections 416 may be of a different shape and dimensions. It is contemplated that all of projections 416 may be of unique shape and dimension. Male fixture 410 may include holes 458 which may be used to receive the shafts 428 of positioning devices 414.

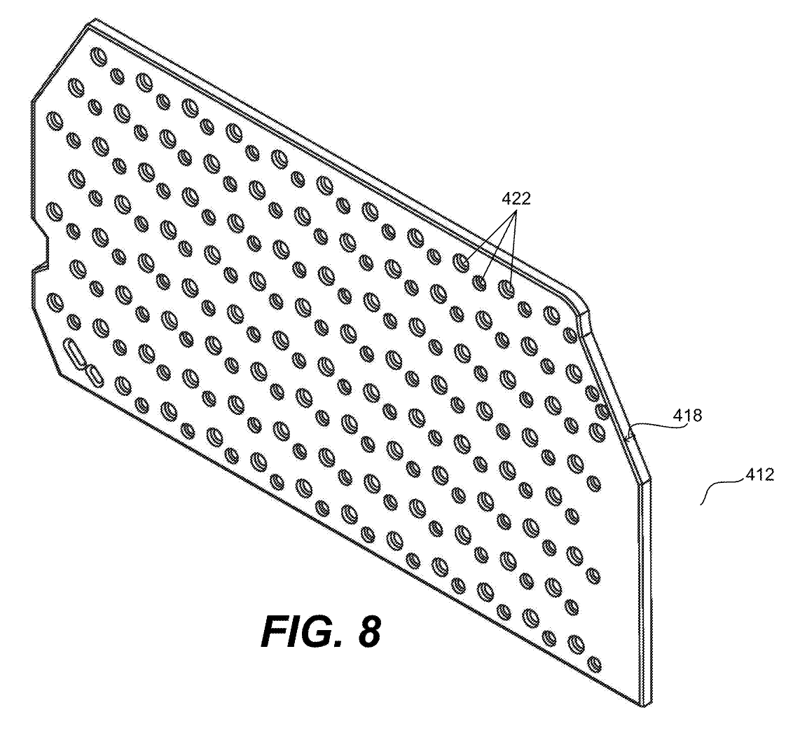

FIG. 8 is a diagrammatic illustration of an exemplary female fixture 412 of the fourth exemplary bending tool 400. Female fixture 412 may include a plurality of nests 422 recessed into top surface 420. Nests 422 may correspond to the plurality of projections 416. Each of the plurality of nests 422 may be sized and dimensioned to receive a corresponding projection 416. Female fixture 412 may have a first height 418, and nests 422 may include bottoms 424 (not shown) a distance below first height 418.

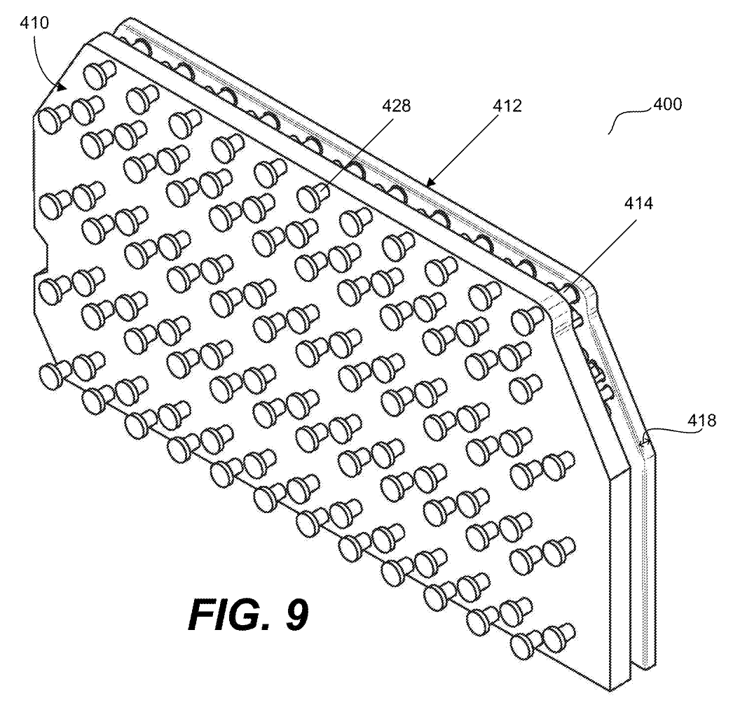

FIG. 9 is a diagrammatic illustration of the exemplary fourth bending tool 400. As shown, male fixture 410 may be disposed opposite female fixture 412 such that the plurality of projections 416 may be aligned with the plurality of nests 422. The shafts 428 of positioning devices 414 may extend through holes 458.

Operation of bending tool 400 is similar to the operation of bending tool 100. As force is applied to male fixture 410, positioning devices 414 act to hold a circuit board or other device to be bent in position such that the contacts are aligned with projections 416 and nests 422, as projections 416 move toward female fixture 412. The outer surfaces 417 of the projections 416 are received by female fixture 412 at a predetermined distance below the first height 418, and the contact of the circuit board is bent. It is contemplated that at least some of the plurality of projections 416 may move together towards female fixture 412 at the same rate, such that all contacts of the circuit board are bent at once. It is also contemplated that bending tool 400 may employ some or all of the mechanisms of bending tools 100, 200, and 300. For example, some or all of nests 422 may be formed by the movement of a movable portion, as discussed with respect to bending tool 200. By way of further example, some or all of projections 416 may include multiple portions extending various degrees from male fixture 410, as discussed with respect to bending tool 300.

Though described with reference to a circuit board, the disclosure is not limited to use with a circuit board. For example, the tool may be applied to other applications in which precise bending is necessary, e.g., machining pieces and tools that must have an exact bend and decorating applications in which a uniform appearance is desired.

It will be apparent to those skilled in the art that various modifications and variations can be made to the bending tool. Other embodiments will be apparent to those skilled in the art from consideration of the specification and practice of the disclosed bending tool. It is intended that the specification and examples be considered as exemplary only, with a true scope being indicated by the following claims and their equivalents.

What is claimed is:

1. A bending tool comprising:
a male fixture comprising a projection with an outer surface;
a female fixture configured to receive the projection, the female fixture having a first height in a direction substantially parallel to the projection; and
a positioning device disposed between the male fixture and the female fixture;
wherein the male fixture is configured to move between a starting position and an ending position in which the outer surface of the projection is received by the female fixture at a pre-determined distance below the first height.

2. The bending tool of claim 1, wherein the male fixture is configured to be fixed to a ram.

3. The bending tool of claim 1, wherein a first portion of the outer surface of the projection is received at the pre-determined distance below the first height and a second portion of the outer surface of the projection is received at a second pre-determined distance below the first height, the second pre-determined distance below the first height being different that the pre-determined distance below the first height.

4. The bending tool of claim 1, wherein one or both of the male fixture and the female fixture comprise hardened tool steel.

5. The bending tool of claim 1, wherein the female fixture further comprises a nest configured to receive the male fixture.

6. The bending tool of claim 5, wherein a mouth of the nest has at least one curved edge.

7. The bending tool of claim 1, wherein the pre-determined distance may be varied.

8. The bending tool of claim 1, wherein the male fixture further comprises a second projection with a second outer surface and the female fixture is further configured to receive the second projection, and wherein the second outer surface is received by the female fixture at a second pre-determined distance below the first height when the male fixture is in the ending position.

9. The bending tool of claim 8, wherein the pre-determined distance and the second pre-determined distance are the same.

10. The bending tool of claim 8, wherein the pre-determined distance and the second pre-determined distance are different.

11. A bending tool comprising:
a male fixture comprising a projection with an outer surface;
a female fixture configured to receive the projection, the female fixture having a first height in a direction substantially parallel to the projection and comprising a fixed portion and a movable portion, the movable portion configured to move from a resting height to a second height below the first height; and
a positioning device disposed between the male fixture and the female fixture;
wherein the male fixture is configured to move between a starting position and an ending position in which the outer surface of the projection is received by the female fixture at a pre-determined distance below the first height, and
wherein the projection causes the movable portion to move from the resting height to the second height when the male fixture is received by the female fixture.

12. The bending tool of claim 11, wherein the male fixture is configured to be fixed to a ram.

13. The bending tool of claim 11, wherein one portion of the outer surface of the projection is received at the pre-determined distance below the first height and a second portion of the outer surface of the projection is received at a second pre-determined distance below the first height, the second pre-determined distance below the first height being different that the pre-determined distance below the first height.

14. The bending tool of claim 11, wherein one or both of the male fixture and the female fixture comprise hardened tool steel.

15. The bending tool of claim 11, wherein the pre-determined distance may be varied.

16. The bending tool of claim 11, wherein the fixed portion defines a channel through which the movable portion moves.

17. The bending tool of claim 16, wherein the channel comprises at least one curved edge.

18. The bending tool of claim 11, wherein the female fixture further comprises a spring.

19. The bending tool of claim 18, wherein the movable portion comprises a base and a top portion, the top portion nearer the male fixture than the base, and wherein the spring is located at the base of the movable portion.

20. A bending tool for bending contacts on a circuit board, comprising:
a plurality of male fixtures each comprising a projection with an outer surface;
a plurality of female fixtures each corresponding to one of the plurality of male fixtures and configured to receive the projection of the corresponding male fixture, each female fixture having a first height in a direction substantially parallel to the projection of the corresponding male fixture; and
a positioning device configured to hold the circuit board such that each contact is positioned between one of the plurality of male fixtures and the corresponding female fixture;
wherein to bend the contacts, each male fixture is configured to move between a starting position and an ending position in which the outer surface of the projection is received by the corresponding female fixture at a pre-determined distance below the first height.
